(19) United States
(12) Patent Application Publication
(10) Pub. No.: US 2010/0173679 A1
(43) Pub. Date: Jul. 8, 2010

(54) APPARATUS AND METHOD FOR CONTROLLING TURNING ON/OFF OPERATION OF DISPLAY UNIT IN PORTABLE TERMINAL

(75) Inventor: Jin Seok Moon, Daegu Metropolitan City (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/652,860

(22) Filed: Jan. 6, 2010

(30) Foreign Application Priority Data
Jan. 6, 2009 (KR) 10-2009-0000872

(51) Int. Cl. H04M 1/00

(52) U.S. Cl. 455/566

(57) ABSTRACT

An apparatus and method for controlling a display unit controls a turning on/off operation of a display unit in a portable terminal having a touch screen. A contact area of the touch screen is detected in a call mode of the portable terminal. A determination is made as to whether or not a range of the touched area is equal to or greater than a preset threshold. The display unit is turned-off if a range of the touched area is equal to or greater than a preset threshold. The display unit is turned on if a release of the touch from the touch screen is detected while the display unit is being turned-off.

### CLAIM OF PRIORITY

This application claims priority from an application entitled “APPARATUS AND METHOD FOR CONTROLLING TURNING ON/OFF OPERATION OF DISPLAY UNIT IN PORTABLE TERMINAL” filed in the Korean Intellectual Property Office on Jan. 6, 2009 and assigned Serial No. 10-2009-0000872, the contents of which are incorporated herein by reference in its entirety.

### BACKGROUND OF THE INVENTION

1. Field of the Invention

The present invention relates to displays installed to portable terminals. More particularly, the present invention relates to an apparatus and method for controlling a powering on/off operation of a display unit in a portable terminal, by using a touch screen installed to the portable terminal.

2. Description of the Related Art

In general, portable terminals include a liquid crystal display (LCD), and in the future may include other types of thin film display technology, and such terminals display the information regarding their respective operating states thereon, so that users can easily ascertain the status of their portable terminals. The LCD remains in a turned-on (i.e. powered-on) state for a certain period of time even while the portable terminals are operated in a call mode wherein the portal device is typically pressed against a user's ear and thus the screen cannot be viewed by the user. That is, since electric power is supplied to the LCD in a call mode, the portable terminal wastes its battery energy. This reduces the remaining battery capacity and decreases the operation time of the portable terminal. Considering that in the near future a sizeable majority of the Earth's population may own such portable devices, when considering on a global scale the amount of wasted battery energy, plus the electricity required to recharge such batteries, often leads to an unnecessary use of fossil fuels to generate electricity that may contribute to global warming.

In particular, since users cannot arbitrarily control the turning on/off operation of the LCD in portable terminals while operating the terminal for audible communication, the LCD keeps displaying information during call waiting or during a call. That is, while the user is holding the portable terminal to his/her ear and is making a call, the LCD is still turned on and displays information, such as a call state, call time, etc. Therefore, the LCD wastes battery energy for a certain period of time.

In recent years, much research has been conducted to resolve the waste of battery energy in portable terminals. There have been several proposals to prevent battery energy wastage by the LCD of the portable terminal. For example, if a key for an outgoing call or a call answer key according to an incoming call is input to a portable terminal and thus a call has been established with another portable terminal, one of the conventional system turns off the LCD to allow the portable terminal user to make a call, and then turns on it after terminating the call. Another conventional system has been used where, if a portion of the user's body, for example, the face, approaches a proximity sensor installed to portable terminals and the proximity sensor detects the approach, the LCD is turned-off.

Although the conventional systems can prevent the energy wastage by the LCD only during the call, they have disadvantages in that the user cannot use additional functions in the portable terminals on many occasions. Examples are cases where the user wishes to check information through the LCD during the call, such as the user writing a text message through the portable terminal while making a call with hands-free device such as an earphone/headset hands-free type, and the user checks a caller ID of an incoming call during the call. Also, the conventional system using a proximity sensor must install additional parts for controlling the LCD, such as a proximity sensor, thereby increasing the manufacturing costs of the portable terminals and requires installation space for the additional parts. In particular, since the conventional system must supply electric power to drive the proximity sensor, it still has the potential to waste energy.

### SUMMARY OF THE INVENTION

The present invention provides an apparatus and method that automatically controls a turning on/off operation of a display unit in a portable terminal in a call mode.

The present invention further provides an apparatus and method that controls a turning on/off operation of a display unit in a portable terminal, using a touch screen, in a call mode.

The present invention further provides an apparatus and method that controls a turning on/off operation of a display unit in a portable terminal and general touch inputs, according to an area of a touch screen where an object (a portion of the user's body) contacts the touch screen when the portable terminal is in a call mode.

In accordance with an exemplary embodiment of the present invention, the present invention provides a method for controlling a display unit of a portable terminal, including: detecting a touch on an area of a touch screen in a call mode of the portable terminal; determining whether a range of the touched area is equal to or greater than a preset threshold; turning off the display unit if a range of the touched area is equal to or greater than the preset threshold; and turning on the display unit if a release of touch from the touch screen is detected while the display unit is being turned-off.

In accordance with another exemplary embodiment of the present invention, the present invention provides a portable terminal including: a radio frequency (RF) communication unit for performing communication; a touch screen, the touch screen including a touch detecting unit for detecting a user's touch and providing information regarding the user's touch, and a display unit for displaying screen data of the portable terminal and for being turned on/off according to the control corresponding to the information; and a controller for determining an area that is touched according to the information output from the touch detecting unit when the portable terminal is in a call mode, and for turning off the display unit if the touched area is equal to or greater than a preset threshold.

### BRIEF DESCRIPTION OF THE DRAWINGS

The many features and advantages of the present invention will become more apparent from the following detailed description in conjunction with the accompanying drawings, in which:

FIG. 1 is a flow chart that describes a method for controlling a turning on/off operation of a display unit using a touch screen, according to an exemplary embodiment of the present invention;

FIGS. 2a to 2c are views that describes a method for distinguishing between a touch input action and an action for controlling a turning on/off operation of a display unit, according to an exemplary embodiment of the present invention;

FIGS. 3a to 3c are views that describes a method for distinguishing between a touch input action and an action for controlling a turning on/off operation of a display unit, according to another exemplary embodiment of the present invention; and

FIG. 4 is a schematic block diagram illustrating a portable terminal according to an exemplary embodiment of the present invention.

### DETAILED DESCRIPTION

Hereinafter, exemplary embodiments of the present invention are described in detail with reference to the accompanying drawings. In the drawings, the same or similar elements are denoted by the same reference numerals even though they are depicted in different drawings. In the following description, a detailed description of known functions and configurations incorporated herein may be omitted when it may make obscure appreciation of the subject matter of the present invention by a person of ordinary skill in the art.

The present invention relates to an apparatus and method for controlling a turning on/off operation of a display unit of a portable terminal. In an embodiment of the present invention, the portable terminal includes touch screen.

In an exemplary embodiment of the present invention, the portable terminal includes a touch screen having an input function and an output function. The touch screen may be comprised of an LCD and a touch detecting unit. While the portable terminal is operated in a call mode, the turning on/off operation of the LCD can be controlled in an automatic method, using the touch screen.

Although an exemplary embodiment of the present invention is implemented with a capacitive overlay touch screen, it should be understood that the present invention is not limited to the exemplary embodiment used for illustrative purposes. For example, it will be appreciated that the present invention can also be implemented with a resistive overlay touch screen, a surface acoustic wave touch screen, a transmitter type touch screen, an infrared beam touch screen, etc., just to same some possible examples.

In an exemplary embodiment of the present invention, the capacitive overlay touch screen can detect the change in the capacitance at a contact area thereon where conductive objects, such as the user's body, contacts the touch screen. The change in the capacitance on the touch screen may be proportional to the contact area of the object.

In an exemplary embodiment of the present invention, after a touch detected area (the range of touch area) is identified through the change in the capacitance that has occurred on the touch screen in a call mode, it can be distinguished whether or not the touch action corresponds to a general touch input action or an LCD turning on/off operation, according to the touch detected area. If the touch detected area is equal to or greater than a preset threshold, the LCD is turned-off. When the change in the capacitance is detected on the touch screen in a state where the LCD is turned-off, the LCD is turned on again.

In the following detailed description regarding a method for controlling a turning on/off operation of the LCD in a portable terminal using a touch screen, includes reference to the accompanying drawings. In an exemplary embodiment of the present invention, the portable terminal includes the touch screen.

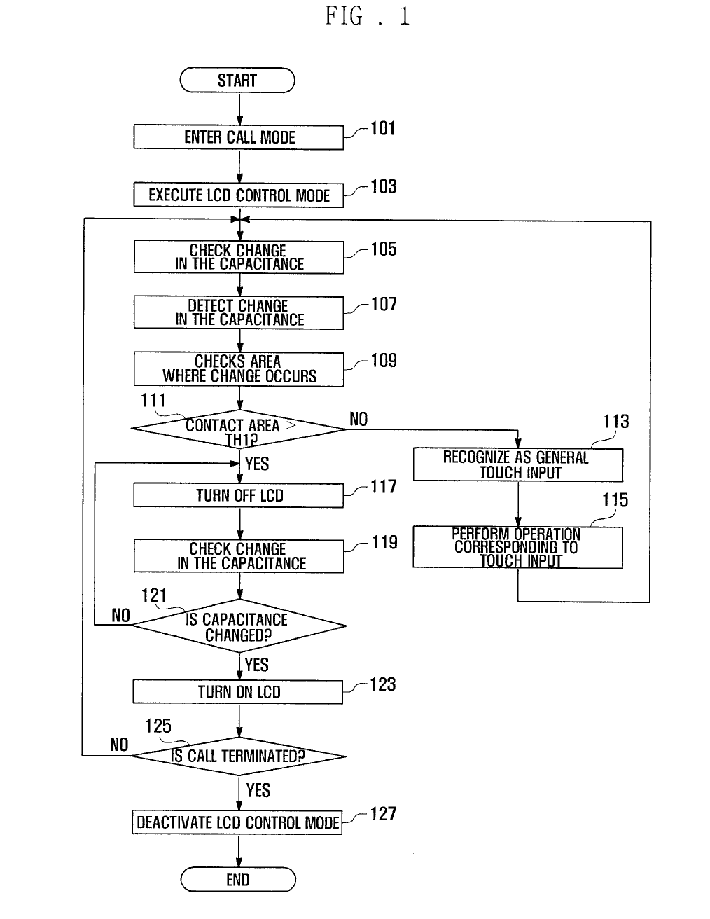

FIG. 1 is a flow chart that describes a method for controlling a turning on/off operation of a display unit using a touch screen, according to an exemplary embodiment of the present invention.

Referring now to FIG. 1, at step (101), when the portable terminal enters a call mode, the portable then executes an LCD control mode (103). The LCD control mode refers to a mode where the turning on/off operation of the LCD is adaptively controlled when the portable terminal is operated in a call mode. That is, when the portable terminal enters a call mode, the LCD control mode is executed to identify a contact area (contact range) according to the change in the capacitance so that the turning on/off operation of the LCD and operations according to general touch inputs can be performed. A detailed description is provided regarding the operations in the LCD control mode.

When the LCD control mode is executed at step (103), the portable terminal checks the change in the capacitance at step (105). That is, the portable terminal may detect a touch action generated as an object approaches or contacts the touch screen. The portable terminal can also detect the coordinates of an area where the touch is detected. The portable terminal can recognize the touch detected area through the change in the capacitance as the object approaches or contacts the touch screen.

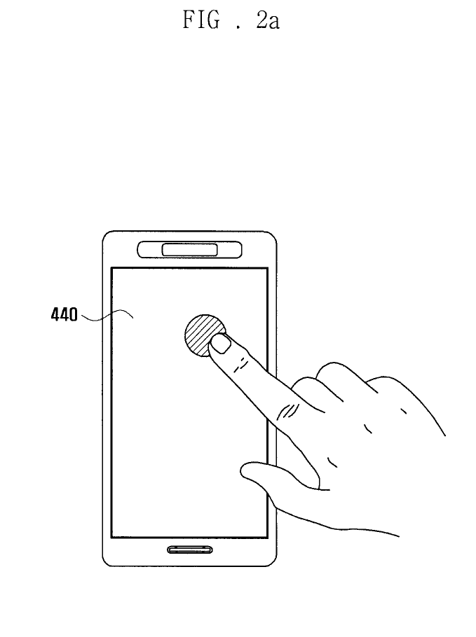

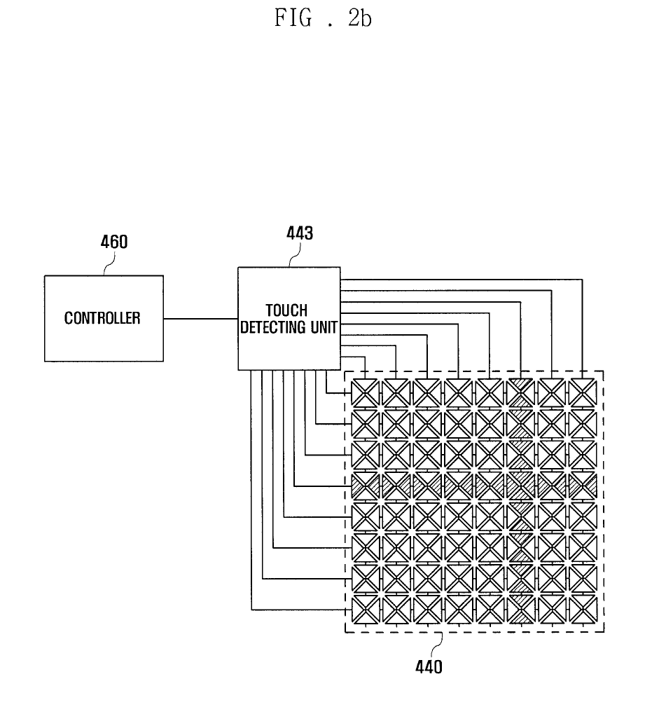

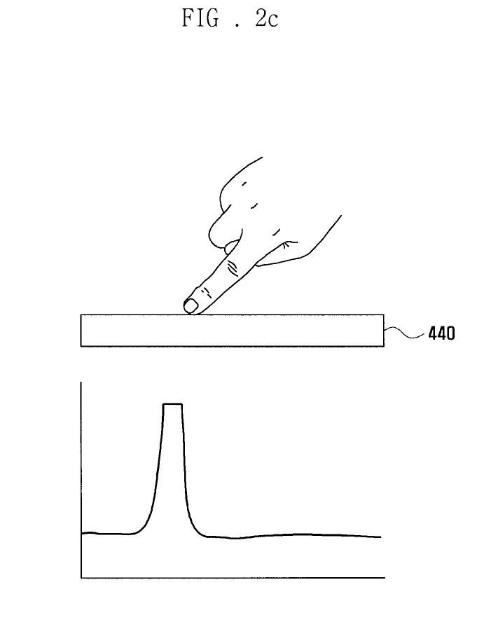

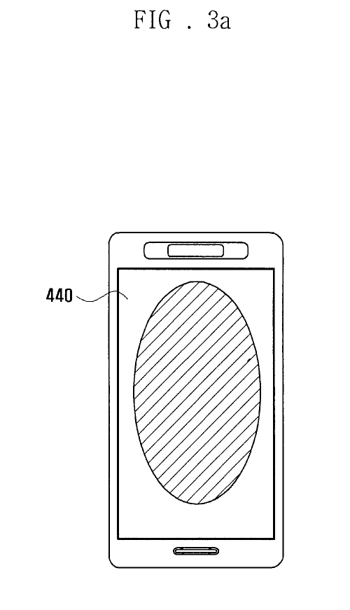

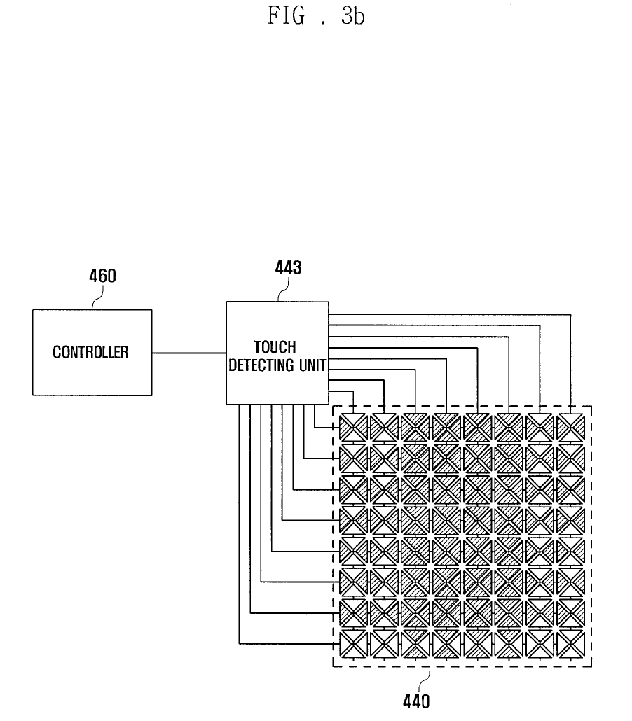

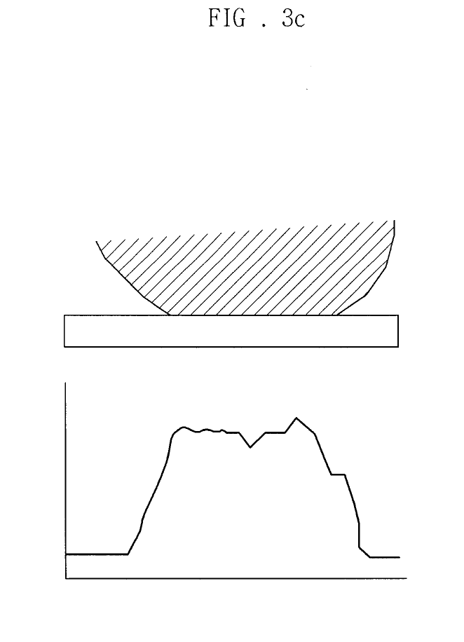

When the portable terminal detects the change in the capacitance at step (107), it checks a contact area where the change in the capacitance has occurred at step (109). The contact area refers to one point or a plurality of points on the touch screen where an object (a portion of the user's body) contacts the touch screen. A description regarding the contact area will be explained in detail with reference to FIGS. 2a to 2c and FIGS. 3a to 3c.

After checking a contact area where the change in the capacitance has occurred, at step (111) the portable terminal determines whether the contact area where the capacitance is changed, i.e., the point, is equal to or greater than a preset threshold Th1. The threshold is a reference value for performing an LCD turning off operation. That is, the threshold refers to the minimum number of points required to identify the change in the capacitance. The threshold may be set, for example, by portable terminal manufacturers or users. If the threshold is set as a relatively small value (i.e., a small number of points), the LCD turning-off controlling operation may be sensitive. On the contrary, if the threshold is set as a relatively large value (i.e., a large number of points), the LCD turning-off controlling operation may be insensitive.

For example, if the threshold is set as a relatively small value, for example to illustrate this teaching, three points, the portable terminal detects the change in the capacitance at three or more points in the LCD control mode and then turns off the LCD. That is, if the portable terminal recognizes the change in the capacitance at only three points in a call mode, it turns off the LCD. On the other hand, if the threshold is set as a relatively large value, for example to illustrate this teaching, ten points, the portable terminal detects the change in the capacitance at ten or more points in the LCD control mode and then turns off the LCD. That is, if the portable terminal recognizes the change in the capacitance of at least ten points in a call mode, it turns off the LCD. A person of ordinary skill in the art should also understand and appreciate that the claimed invention should not be interpreted with the number of three points and ten points as an implied range, and these numbers were provided only to aid in understanding the claimed invention.

With continued reference to FIG. 1, at step (111) if the portable terminal ascertains that the contact area is less than a preset threshold Th1, the portable terminal recognizes the change in the capacitance as a general touch input (113). An example of the general touch input at 113 may be a particular touch input after the user requests a call connection. After that, the portable terminal performs a function corresponding to the input touch (115). For example, while the portable terminal is communicating with another portable terminal by signals to establish a call connection, the portable terminal may also activate a menu or control the volume according to the input touch.

Alternatively, at step (111) if the portable terminal ascertains that the contact area is less than a preset threshold Th1, the method may be modified as follows. That is, if the portable terminal ascertains that the contact area is less than a preset threshold Th1 (or a first threshold Th1) at (111), the portable terminal may compare the contact area with a second threshold Th2 to determine whether the contact area corresponds to a general touch input. If the second threshold Th2 may be set as two points for a portable terminal supporting a multi-touch operation and as one point for a portable terminal supporting a single-touch operation. If the contact area corresponds to the second threshold Th2, the portable terminal recognizes the contact area as a general touch input.

However, at step (111) if the portable terminal ascertains that the contact area is equal to or greater than a preset threshold Th1, the portable terminal turns off its own LCD (117).

After turning off the LCD at 117, the portable terminal retains the turned-off state of the LCD and checks the change in the capacitance on the touch screen (119). In general, the capacitive-type touch screen is operated in such a way that the touch screen accumulates charges on the surface, generates a high frequency, analyzes the loss of charge or the change of a high frequency waveform if the user's finger inputs a touch action, and recognizes the touched point. The change in the capacitance at 119 may be the loss of charge or the change of a high frequency waveform.

Subsequently at step (121), the portable terminal determines whether the change in the capacitance occurs. For example, in general, the user of a portable terminal typically holds the portable terminal close to his/her face during a call mode. The touch screen often makes contact the face during the call and then the touch screen is separated from contact with the user's face after the call is terminated. In that case, a portion of the touch screen, which contacted the face during the call and separated therefrom after the call, experiences the change in the capacitance. Through this process, a determination at step (121) is made to ascertain if the change in the capacitance occurs on the touch screen.

If the portable terminal ascertains that the change in the capacitance does not occur at step (121), the portable terminal retains the turned-off state of the LCD at 117. On the contrary, if the portable terminal ascertains that the change in the capacitance has occurred at 121, it switches the turned-off state of the LCD to a turned-on state, i.e., turns on the LCD at step (123).

With reference to FIG. 1 at step (125), the portable terminal determines whether or not the call is terminated. If the portable terminal ascertains that the call is not terminated at step (125), the process returns to 105 and controls the turning on/off operation of the LCD. On the contrary, if the portable terminal ascertains that the call is terminated at step (125), the portable terminal then deactivates the LCD control mode at step (127). After that, the portable terminal performs a function corresponding to a user's request or enters an idle mode.

The following is a detailed description regarding a method for determining whether the change in the capacitance on the touch screen corresponds to a general touch or a touch for turning on/off operation of the LCD, with reference to FIGS. 2a to 2c and FIGS. 3a to 3c.

FIGS. 2a to 2c are views that illustrate a method for recognizing a user's general touch inputs on the touch screen, according to an exemplary embodiment of the present invention.

As shown in FIG. 2a, the user applies a touch input on a particular area on the touch screen 440 to control the operation of the portable terminal. In that case, as shown in FIG. 2b, the touch detecting unit 443 of the portable terminal detects the point where the touch input has occurred on the touch screen 440, and outputs the x- and y-coordinate values of the point to the controller 460. That is, the touch detecting unit 443 recognizes the touched input point as the x- and y-coordinate values.

If the x- and y-coordinate values of the touched point are indicated by (x, y), the capacitance of the point corresponding to the coordinate value (x, y) experiences the change due to a user's touch, i.e., an input touch. As shown in FIG. 2c, if a user's touch is applied to the touch screen 440, the change in the capacitance occurs at the touched point. In general, the capacitive-type touch screen can detect a touch if the change in the capacitance at the touched area is equal to or greater than a preset value.

FIGS. 3a to 3c are views that illustrate a method for detecting distinguishing between a touch input action and an action for controlling a turning on/off operation of an LCD when the user's face contacts the touch screen in a call mode, according to another embodiment of the present invention.

As shown in FIG. 3a, the user holds the portable terminal in a call mode, contacting the touch screen 440 to his/her face. In that case, FIG. 3b the touch detecting unit 443 of the portable terminal recognizes that a plurality of points experience a touch on the touch screen, and outputs information regarding x- and y-coordinate values corresponding to the touched points to the controller 460. That is, the touch detecting unit 443 identifies that a touch input is applied to a plurality of points, crossing x- and y-axes.

If the x- and y-coordinate values of the touched points are indicated by (x₁, y₁), (x₂, y₂), . . . , (xₙ, yₙ), the capacitance of each of the points corresponding to the coordinates (x₁, y₁), (x₂, y₂), . . . , (xₙ, yₙ), experiences the change due to a user's touch, i.e., an input touch. As shown in FIG. 3c, if a user's touch is applied to the touch screen 440, the change in the capacitance occurs at each of the touched points. As shown in FIG. 3c, if the portable terminal detects the change in the capacitance at a plurality of points on the touch screen in a call mode, it turns off the LCD. In order to turn off the LCD, the portable terminal compares the capacitance of each of the points with a preset threshold and then turns off the LCD based the comparison result. If the portable terminal detects the change in the capacitance during the turned-off state of the LCD, it turns on the LCD.

Referring to the exemplary embodiments shown in FIGS. 2a to 2c and 3a to 3c, the portable terminal, according to the present invention, can adaptively control the turning on/off operation of the LCD during the call mode, according to a user's action, or the contact area (contact range) of the user's body with respect to the touch screen.

A detailed description has been provided regarding exemplary embodiments of a method for controlling a turning on/off operation of the LCD of the portable terminal during the call mode, according to the change in the capacitance on the area on the touch screen where a touch input is applied.

The following is a description regarding the portable terminal adapted to the methods of FIGS. 1, 2a to 2c, and 3a to 3c. A person of ordinary skill in the art should understood that the present invention is not limited to the following exemplary embodiment. It will be appreciated that there are many modifications of the exemplary embodiment within the spirit of the invention and the scope of the appended claims.

In the following description, although the portable terminal is explained based on a mobile communication terminal, a person of ordinary skill in the art should understand that the present invention is not in any way limited to the exemplary embodiment.

In an exemplary embodiment of the present invention, the portable terminal can be applied to all types of mobile communication terminals that can be operated through communication protocols for various types of communication systems, and to all information communication devices, multimedia devices, and their applications, which have a touch screen and can provide mobile communication services.

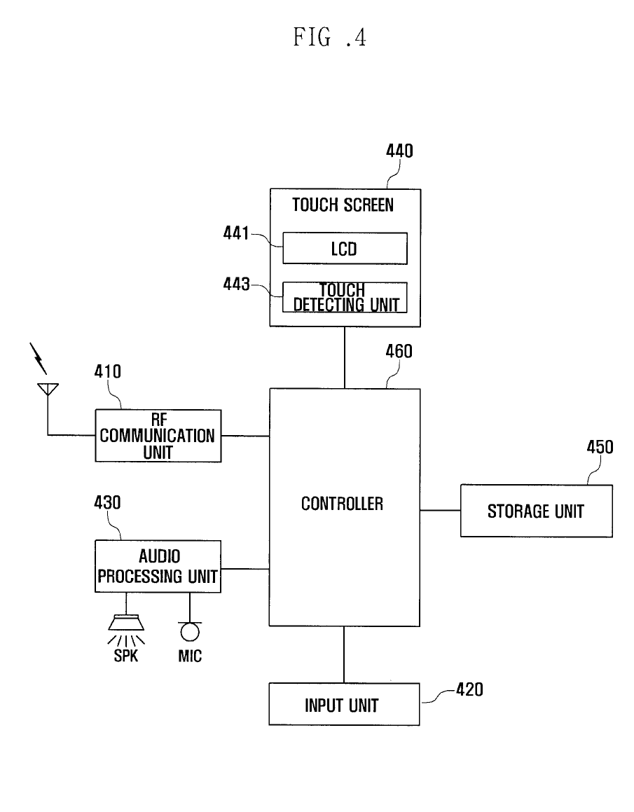

FIG. 4 is a schematic block diagram illustrating a portable terminal according to an exemplary embodiment of the present invention.

As shown in FIG. 4, the portable terminal preferably includes an RF communication unit 410, an input unit 420, an audio processing unit 430, a touch screen 440, a storage unit 450, and a controller 460. The touch screen 440 includes an LCD 450 and a touch detecting unit 443.

The RF communication unit 410 performs wireless communication between the portable terminal and other external systems. The RF communication unit 410 establishes communication channels with mobile communication networks and performs, just to name a few possible examples, voice and video call communications, data communication, etc. therethrough. The RF communication unit 410 includes an RF transmitter and an RF receiver, which may also be embodied as a transceiver. The RF transmitter preferably up-converts the frequency of transmitted signals and amplifies the transmitted signals. The RF receiver preferably low-noise amplifies received RF signals and down-converts the frequency of the received RF signals.

The input unit 420 receives character information. The input unit 420 receives signals related to the settings of a variety of functions and the function controls of the portable terminal and outputs them to the controller 460. The input unit 420 generates signals in response to a user's action. The input unit 420 is preferably implemented with at least one of a keypad and touchpad, etc. The input unit 420 may be integrated with the touch screen 440, so that it can simultaneously serve to perform input and output functions. That is, if the portable terminal is configured to be operated by the touch screen 440, it does not need the input unit 420.

The audio processing unit 430 is connected preferably to a microphone MIC and a speaker SPK. The audio processing unit 430 coverts voice signals from the microphone MIC into data and outputs them to the controller 460. The audio processing unit 430 also outputs voice signals from the controller 460 through the speaker SPK. The audio processing unit 430 can reproduce various types of audio data stored in the portable terminal, for example, an MP3 file, etc., according to a user's selection.

The touch screen 440 serves as an inputting and outputting unit for inputting and outputting functions. The touch screen 440 includes the LCD 441 and the touch detecting unit 443.

The LCD 441 displays screen data generated while the portable terminal is operated and also information regarding the states of the portable terminal according to a user's key operation and function settings. That is, the LCD 441 displays various types of screen data related to the states and operations of the portable terminal. The LCD 441 also displays various types of signals and color information output from the controller 460. In an exemplary embodiment of the present invention, the LCD 441 is turned on/off under the control of the controller 460 while the portable terminal is in a call mode.

The touch detecting unit 443 is placed in the LCD 441 and detects a user's touches applied on the surface of the touch screen 440. The user's touches refer to contacts by a portion of the user's body, such as the finger or the face. When a portion of the user's body contacts an area on the touch screen 440, the touch detecting unit 443 detects the coordinates of the area and outputs them to the controller 460. The touch detecting unit 443 can detect the change in the capacitance that occurs as a portion of the user's body, for example, the finger, the face, etc., touches the surface of the touch screen 440 or removes therefrom. These operations have already been explained in the description referring to FIG. 1, FIGS. 2a to 2c, and FIGS. 3a to 3c. That is, the touch detecting unit 443 can detect a touched area on the touch screen 440 through, for example, the change in the capacitance. The change in the capacitance occurs as a conductive object or a portion of the user's body, for example, the finger, the face, etc., contacts the touch screen 440.

The touch screen 440 typically refers to a device configured as an input device and a display device are integrated as a single device, so that it can receive and display. The touch screen 440 includes the LCD 441 for displaying various types of screen data and the touch detecting unit 443 for detecting touches generated by a user, generating signals according to the detected touches, and outputting the generated signals to the controller 460. The controller 460 can perform functions based/identified on the touched area, according to the signals output from the touch detecting unit 443.

The storage unit 450 preferably includes read only memory (ROM), random access memory (RAM), etc. The storage unit 450 can store various types of data generated or used in the portable terminal. The various types of data include data generated as application programs are executed in the portable terminal, and all types of data that can be storable and are generated using the portable terminal or received from external systems (base station, other portable terminals, personal computers, etc.). In an exemplary embodiment of the present invention, the data includes information regarding user interfaces provided by the portable terminal, information regarding the settings related to the functions of the portable terminal, information regarding the settings for controlling the turning on/off operation of the LCD, etc. In particular, the information regarding the settings for controlling the turning on/off operation of the LCD includes information regarding the settings of the threshold, information regarding the settings for activating or deactivating the functions according to the present invention, etc.

The storage unit 450 stores application programs for controlling the entire operation of the portable terminal. The storage unit 450 can also store an application program for controlling a turning on/off operation of the LCD using the touch screen 440. These application programs perform the operations described above, referring to FIG. 1, FIGS. 2a to 2c, and FIGS. 3a to 3c. These application programs can be stored, for example, in an application storage area (not shown) of the storage unit 450. The storage unit 450 can be configured to include one or more buffers that temporarily store data generated while the application programs are executed.

The controller 460 preferably controls the entire operation of the portable terminal and the signal flow among the elements in the portable terminal. Examples of some of the elements preferably include the RF communication unit 410, the input unit 420, the audio processing unit 430, the touch screen 440, the storage unit 450, etc.

The controller 460 can identify a touched area by using the information output from the touch screen 440, in particularly, the touch detecting unit 443. That is, as shown in FIGS. 2a to 2c and FIGS. 3a to 3c, the touch detecting unit 443 can detect the touched areas from the crossing points of the x- and y-coordinates. The touch detecting unit 443 detects a particular touch and then outputs information regarding a coordinate value corresponding to the touched area to the controller 460. In an exemplary embodiment of the present invention, if the touch detecting unit 443 detects a touch when the portable terminal is in a call mode, it outputs information, indicating that, for example, a change in the capacitance has occurred at the touched area, to the controller 460.

In an exemplary embodiment of the present invention, when the portable terminal enters a call mode, the controller 460 activates the LCD control mode. The controller 460 controls a tuning on/off operation of the LCD according to the information output from the touch detecting unit 443 during the LCD control mode.

In an exemplary embodiment of the present invention, the controller 460 can detect the change in the capacitance using the information output from the touch detecting unit 443 when the portable terminal is in a call mode. When the controller 460 detects the change in the capacitance, the controller 460 identifies the area where the change in the capacitance has occurred and compares the area with a preset threshold. If the controller 460 ascertains that the area is equal to or greater than the threshold, the controller initiates a turn-off the LCD 441.

The controller 460 checks the change in the capacitance using the information output from the touch detecting unit 443 in a state where the LCD 441 is turned-off. When the controller 460 detects the change in the capacitance in a state where the LCD 441 is turned-off, the controller initiates turning on the LCD 441.

The state where the LCD is being turned-off may be a case where the user holds the portable terminal to the ear and his/her face is contacting the touch screen 440. Therefore, if the LCD is turned-off, the controller 460 can detect the change in the capacitance using the information provided from the touch detecting unit 443 and thus determine whether the his/her face removes from the touch screen 440.

As such, the controller 460 can control the entire operation of the portable terminal. It should be understood that the functions of the controller 460 can be controlled by software.

The controller 460 may further include a baseband module for providing a mobile communication service via the portable terminal. The baseband module may be installed into the controller 460 and the RF communication unit 410, respectively. Alternatively, the baseband module may be separately installed to the portable terminal from the controller 460 and the RF communication unit 410.

Although, for the sake of convenience, the portable terminal according to an exemplary embodiment of the present invention is schematically configured as shown in FIG. 4, it should be understood that the present invention is not limited to the exemplary embodiment.

For example, according to the purposes, the portable terminal may further include a digital broadcast module for receiving digital broadcast signals, a short-range communication module for performing short-range communication, an Internet communication module for performing communication via an Internet network, etc. With the convergence of digital devices, there may be many digital devices and modifications thereof, not listed in the application, and, it will be appreciated that they can also be included in the portable terminal. Also, It will be appreciated that, according to the purposes, the portable terminal may be implemented by omitting a particular element or replacing it with other elements.

As described above, the apparatus and method according to the present invention can control a turning on/off operation of a display unit of the portable terminal having a touch screen, using the touch screen. Therefore, the apparatus and method does not need proximity sensors in order to control the display unit. The apparatus and method according to the present invention can control the display unit of the portable terminal having a touch screen with software, instead of requiring hardware. Therefore, the apparatus and method can reduce the manufacturing costs of the portable terminals.

The above-described methods according to the present invention can be realized in hardware or as software or computer code that can be stored in a recording medium such as a ROM, an RAM, disk, or a magneto-optical disk, or downloaded over a network, so that the methods described herein can be rendered in such software using a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims. Also, a person of ordinary skill in the art should understand and appreciate that touch is not limited to fingers or other parts of a human body making contact with the screen. A stylus, for example, could also be used in a resistive touch screen.

What is claimed is:

1. A method for controlling a display unit of a portable terminal, comprising:
detecting a touch on an area of a touch screen in a call mode of the portable terminal;
determining whether a range of the touched area is equal to or greater than a preset threshold;
turning off the display unit if a range of the touched area is equal to or greater than said preset threshold; and
turning on the display unit if a release of touch from the touch screen is detected while the display unit is being turned-off.

2. The method of claim 1, wherein detecting a touch comprises:
executing a display unit control mode when the portable terminal enters the call mode;
checking whether a change in a capacitance has occurred on the touch screen in the display unit control mode;
detecting a touch if the touch causes the change in the capacitance on the touch screen in the display unit control mode.

3. The method of claim 1, wherein detecting a touch comprises:
executing a display unit control mode when the portable terminal enters the call mode;
checking whether a change in the resistance has occurred on the touch screen in the display unit control mode;
detecting a touch if the touch causes the change in the resistance on the touch screen in the display unit control mode.

4. The method of claim 1, wherein said touch screen comprises a touch screen selected from the group consisting of a resistive overlay touch screen, a surface acoustic wave touch screen, a transmitter type touch screen, and an infrared beam touch screen.

5. The method of claim 2, wherein determining whether a range of the touched area is equal to or greater than a preset threshold comprises:
checking a contact area where the change in the capacitance has occurred on the touch screen; and
determining whether or not the contact area is equal to or greater than the preset threshold.

6. The method of claim 5, further comprising:
turning off the display unit if the contact area is equal to or greater than the threshold; and
recognizing the input touch as a general touch if the contact area is less than the threshold.

7. The method of claim 6, wherein turning on the display unit comprises:
checking whether or not the change in the capacitance occurs on the touch screen while the display unit is being turned-off;
retaining the turned-off state of the display unit if the change in the capacitance has not occurred; and
switching the turned-off state of the display unit to a turned-on state if the change in the capacitance has occurred.

8. The method of claim 5, wherein the contact area indicates one point or a plurality of points on the touch screen, which are touched by an object.

9. The method of claim 8, wherein the threshold indicates the minimum number of points required to identify the change in the capacitance, serving as a reference to turn off the display unit.

10. The method of claim 2, wherein the display unit control mode comprises modes where a contact area is identified where the change in the capacitance occurs on the touch screen when the portable terminal is in a call mode, and operations of turning on/off the display unit and operations corresponding to general touches are controlled according to the contact area.

11. The method of claim 1, wherein detecting a release of the touch from the touch screen is detecting the change in the capacitance at a certain area where the touch has occurred on the touch screen.

12. The method of claim 2, further comprising:
determining whether the call mode is terminated; and
deactivating the display unit control mode if the call mode is terminated.

13. A portable terminal comprising:
a radio frequency (RF) communication unit for performing communication;
a touch screen, the touch screen including a touch detecting unit for detecting a user's touch and providing information regarding the user's touch, and a display unit for displaying screen data of the portable terminal and for being turned on/off according to the control corresponding to the information; and
a controller for determining an area that is touched according to the information output from the touch detecting unit when the portable terminal is in a call mode, and for turning off the display unit if the touched area is equal to or greater than a preset threshold.

14. The portable terminal of claim 13, wherein the controller turns on the display unit if a release of the touch from the touch screen is detected according to the information output from the touch detecting unit while the display unit is being turned-off.

15. The portable terminal of claim 13, wherein the touch screen comprises a touch screen selected from the group consisting of a resistive overlay touch screen, a surface acoustic wave touch screen, a transmitter type touch screen, and an infrared beam touch screen.

16. The portable terminal of claim 14, wherein the controller executes a display unit control mode when the portable terminal enters the call mode, recognizes a change in a capacitance occurred on a certain area of the touch screen, in the display unit control mode, according to the information output from the touch detecting unit, and deactivates the display unit control mode when the call mode is terminated.

17. The portable terminal of claim 16, wherein the controller checking a contact area where the change in the capacitance has occurred on the touch screen, and determines whether or not the contact area is equal to or greater than the preset threshold.

18. The portable terminal of claim 17, wherein the controller turns off the display unit if the contact area is equal to or greater than the threshold, and recognizes the input touch as a general touch if the contact area is less than the threshold.

19. The portable terminal of claim 18, wherein, if the change in the capacitance has occurred, the controller switches the turned-off state of the display unit to a turned-on state, according to the information output from the touch detecting unit, in a state where the display unit is being turned-off.

20. The portable terminal of claim 17, wherein the contact area indicates one point or a plurality of points on the touch screen, which are touched by an object.

21. The portable terminal of claim 20, wherein the threshold indicates a minimum number of points required to identify the change in the capacitance, serving as a reference to turn-off the display unit.

22. The portable terminal of claim 16, wherein the display unit control mode comprises modes where a contact area is identified where the change in the capacitance occurs on the touch screen when the portable terminal is in a call mode, and operations of turning on/off the display unit and operations corresponding to general touches are controlled according to the contact area.

23. The portable terminal of claim 14, wherein the release of the touch from the touch screen is detected by the change in the capacitance at a certain area where the touch has occurred on the touch screen.
